(19) United States
(12) Patent Application Publication
(10) Pub. No.: US 2002/0080167 A1
(43) Pub. Date: Jun. 27, 2002

(54) System for storing and accessing information units

(76) Inventors: Anton Oguzhan Alford Andrews, Eindhoven (NL); Fiona Rees, Eindhoven (NL); Bendik Torvin, Eindhoven (NL)

Correspondence Address: Philips Electronics North America Corp., 580 White Plains Road, Tarrytown, NY, 10591, US

(21) Appl. No.: 09/982,277

(22) Filed: Oct. 17, 2001

(30) Foreign Application Priority Data
Oct. 18, 2000 (EP) 00203617.6

(51) Int. Cl. G09G 5/00

(52) U.S. Cl. 345/738

(57) ABSTRACT

The invention relates to a system for storing and accessing information units. It comprises at least one storage device for storing the information units, at least one presentation device for presenting the information units, and a network connecting the storage device and the presentation device. At least one of the information units is assigned to a physical location. The system further comprises positioning means for determining the physical location of the presentation device, and presentation control means for controlling the presentation of a respective information unit in dependence on the physical location of the presentation device and on the location to which the respective information unit is assigned.

### FIELD OF THE INVENTION

The invention relates to a system for storing and accessing information units, the system comprising at least one storage device for storing respective ones of the information units, at least one presentation device for presenting the information units and a network connecting the storage device and the presentation device. The invention further relates to a presentation device for presenting information units, to a method for storing and accessing information units, and to a computer program product.

### BACKGROUND OF THE INVENTION

Recent developments in network technology have enabled people to access information from all over the world at any time through their personal computers. For example, the World Wide Web provides a very user friendly user interface for surfing the web and searching for specific information. Undoubtedly, this new technology offers many advantages for both users and publishers of the information, since distributing and accessing the information is no problem anymore. A disadvantage, however, is that users no longer have any incentive to go out to get the desired information. Consequently, there is a risk of people becoming isolated. Moreover, in many cases it makes no sense to put a particular information unit on the World Wide Web because the information is only relevant within a very local context.

### OBJECT AND SUMMARY OF THE INVENTION

It is an object of the invention to provide an improved system and method of the type defined in the opening paragraph. To that end, in the system according to the invention, a respective information unit can be assigned to a physical location, the system further comprising positioning means for determining the physical location of the presentation device, and presentation control means for controlling the presentation of a respective information unit in dependence on the physical location of the presentation device and on the location to which the respective information unit is assigned. Assigning an information unit to a physical location may be achieved by a location attribute indicating an absolute position, e.g. degree of latitude and longitude, or a relative position, e.g. a distance from a particular location, for example from a shop window or a bus-stop, or a specific height or depth with respect to sea-level. In this manner it is expressed that a particular information unit has only relevance to the ‘anchorage’ location indicated by the location attribute. As a result, such an information unit will only be accessible in de vicinity of said anchorage location. A presentation device which is far away from the anchorage location will not be aware of said information unit, or ignore so as not to make the user aware of it. If the presentation device moves more closely to the anchorage location, the user can be made aware of it by presenting a limited representation of the information unit, for example a representative icon or sound. Additionally, the user can be directed to the anchorage location of the information unit, for example by simple arrows, or by a street-map being shown on a display screen wherein a pointer or icon representing the information unit is projected. If the presentation device has moved sufficiently close to the anchorage location, the limited presentation may automatically expand to a full presentation of the information unit, or the user is allowed to do so by explicit request, for example by clicking the icon. Alternatively, any other parameter of the presentation may be varied in accordance with the distance to the anchorage location, for example picture or/sound quality, size of a presented portion of the information unit, sound level, intensity or type of colors used etc. In this way it is achieved that the user is encouraged to actually go to the anchorage location and experience the information unit in the context it was meant for.

In addition to a location attribute, other constraints may be specified as well. An information unit may be relevant at the anchorage location within a certain time frame, enabling people, for example, to access messages (in the evening) about a beautiful sunset at a particular viewpoint. Furthermore, access to an information unit may be restricted to a particular person or group of persons, for example one could leave a message for a specific person at a bus-stop or car-pool meeting point. Furthermore, the lifetime of such a message could be limited to one or a few days.

Preferably, the presentation device is a portable device, for example integrated with a personal digital assistant or a mobile phone. Access to the information units may be established by making a physical connection at an anchorage location, but preferably the network is at least partially wireless, enabling information access by just moving into the vicinity of the anchorage location.

In a preferred embodiment the presentation device enables the user to create and/or modify anchored (or non-anchored) information units himself. So the user could reply to a message at the bus-stop by creating another anchored message, or by just sending a (non-anchored) e-mail. Preferably, anchored information units are created at the anchorage location itself, but this is not a requirement. So one could create a message at home and assign it to a specific location by just entering its coordinates.

The position of a respective presentation device may be determined by any suitable technique known for this purpose, for example by means of a GPS unit, or wireless communication techniques such as bluetooth. It is not important where the information units are actually stored, as long as they are accessible from the locations to which they have been assigned.

It is thus an achievement of the present invention that information can be assigned to specific locations and/or other conditions such as time frames. In this way, people are encouraged to actually go to physical locations where information shows to its full advantage, which leads to a more social networking community. Additionally, the fact that information is only accessible at a specific location may constitute an extra security level, because an unauthorized person has to find out at which location the information is accessible. Finally, the invention may be applied just for fun, for example for creating virtual graffiti without the detrimental effects of real graffiti.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 shows a diagram of a communication network as an embodiment of the system according to the invention,

FIG. 2 schematically shows various degrees of access to an anchored information unit,

FIG. 3 shows an example of a screen representation of a street-map on a presentation device according to the invention.

### DESCRIPTION OF EMBODIMENTS

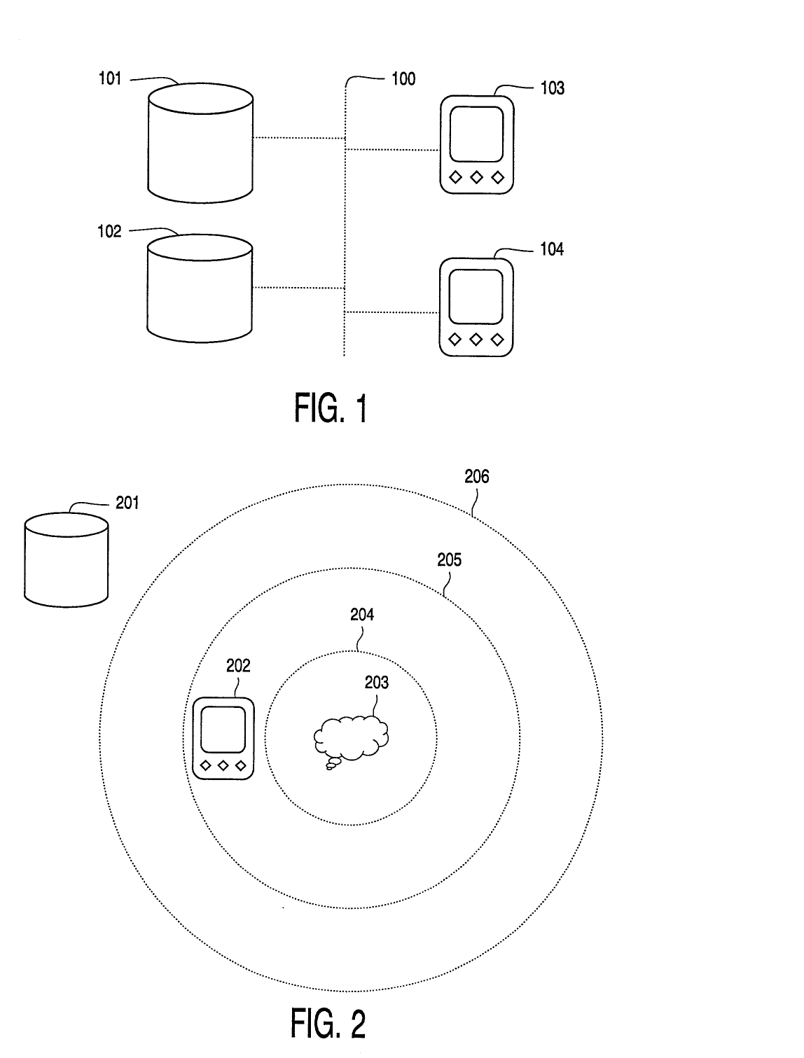

FIG. 1 shows a diagram of a communication network as an embodiment of the system according to the invention. The network 100 enables storage devices 101, 102 and presentation devices 103, 104 to communicate with each other. The network 100 may be completely hard-wired, completely wireless, or a combination of the two. The storage devices 101 and 102 may be located anywhere, and may store any number of information units. These information units can be accessed through the presentation devices 103 and 104. The information units may include text, audio, video or multimedia files, and they may be assigned to one or more specific locations, or be accessible from any part of the network. For example, a user may be able to surf the World Wide Web through any of the presentation devices 103 and 104, and through storage devices 101 and 102, which may be part of a webserver. Preferably, the presentation devices 103 and 104 are portable devices, but they could also have a fixed location. In the latter case, they would enable a user to access information units which are not assigned to any specific location, or which happen to be assigned to the presentation devices' locations.

FIG. 2 schematically shows various degrees of access to an anchored information unit. A storage device 201 stores an information unit 203 assigned to a location which differs from the location of the storage device 201. The information unit 203 can be accessed through a presentation device 202 via a wireless network connection. To which extent the information unit 203 is accessible is determined by the distance between the presentation device 202 and the anchorage location of the information unit 203. In FIG. 2 this is depicted by virtual circles around the anchorage location. If the presentation device 202 would be within the inner circle 204, the user is enabled to request a full presentation of the information unit 203. The current position of the presentation device 202 is between the inner circle 204 and the next circle 205, which means that the user is made aware of the information unit 203, but its presentation is limited to a representative icon. If the presentation device 202 was between the outer two circles 205 and 206, the icon would further shrink to a non-representative sign, e.g. a small dot or cloud, just indicating that the presentation device 202 is close to the anchorage location of an information unit, but not telling anything about its content. If the presentation device 202 was outside the outer circle 206, the user would not be made aware of the nearness of the information unit 203 at all. Consequently, a user carrying the presentation device 202 and approaching the anchorage location of the information unit 203 would firstly be made aware of it, then be provided with some information about its content, and finally be enabled to request a full presentation of it. In an alternative embodiment, the full presentation would start automatically as soon as the presentation device 202 enters the inner circle 204.

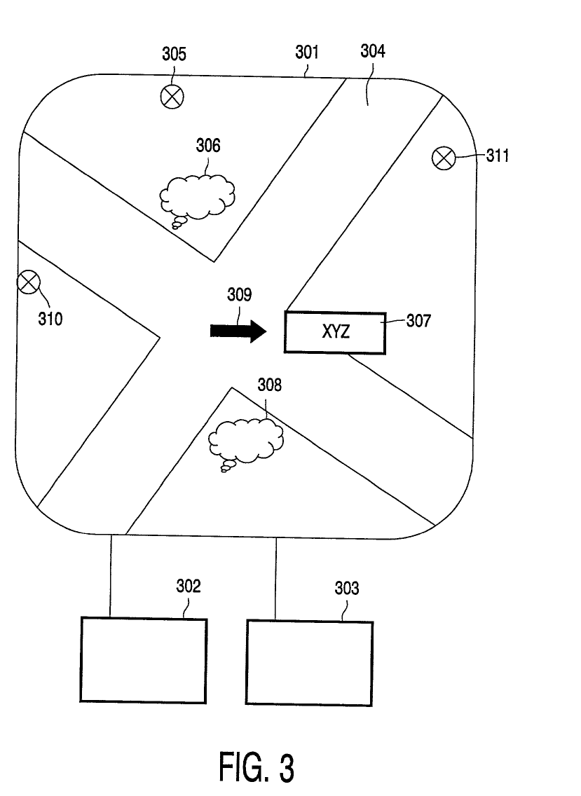

FIG. 3 shows an example of a screen representation of a street-map on a presentation device according to the invention. A display screen 301 of the presentation device displays a street-map 304 representing the direct environment of the presentation device. This is accomplished by means of positioning means 302, which may, for example, include a GPS receiver and mapping means for storing or downloading map data for generating the street-map 304. Presentation control means 303 are provided for controlling to which extent the user has access to the information units. Various representations of information units are depicted in FIG. 3. The position of the presentation device is indicated by the black arrow 309, i.e. close to the street corner which is the anchorage location of information unit 307. The screen representation of information unit 307 (‘icon’ XYZ) is supposed to be representative of its content. The user may request a full presentation if he wishes.

The information units 306 and 308 anchored at the other street corners are represented by small cloud call-outs, which serve to make the user aware of their existence, and give only limited information about their contents, e.g. only about the type of the respective information units. The user would have to go to their respective locations to get more information by means of their representative icons and, eventually, through their full presentation.

Information units 305, 310 and 311 which are even further away from the presentation device are represented by small symbols which just make the user aware of their existence but say nothing about their contents.

In a further embodiment, the street-map 304 is presented in a fish-eye view mode, showing much detail in the center, and showing a large deformed part of the remote environment with less details near the edges of the display screen. Alternatively, the presentation device comprises zooming means for generating various zoomed-in and zoomed-out views of varying degrees of detail. In a zoomed-out view, all representations of information units (even the closest ones) may be small ‘awareness’ symbols in order to keep the screen comprehensible.

The street-map 304 is continuously updated in accordance with the relocations of the presentation device and, depending on the distances between the presentation device and the various anchorage locations, representations of information units change from informative to less informative and vice versa, or appear and disappear completely.

In summary, the invention relates to a system for storing and accessing information units. It comprises at least one storage device for storing the information units, at least one presentation device for presenting the information units and a network connecting the storage device and the presentation device. At least one of the information units is assigned to a physical location. The system further comprises positioning means for determining the physical location of the presentation device, and presentation control means for controlling the presentation of a respective information unit in dependence on the physical location of the presentation device and the location to which the respective information unit is assigned.

Although the invention has been described with reference to particular illustrative embodiments, variants and modifications are possible within the scope of the inventive concept. Thus, for example, information units may be stored at a central storage device, or may be part of a distributed database. They might even be stored on the presentation devices themselves, and communicated to other presentation devices through the network.

The use of the verb “to comprise’ and its conjugations does not exclude the presence of any elements or steps other than those defined in a claim. In the claims, any reference signs placed between parentheses shall not be construed as limiting the claim. The invention can be implemented by means of hardware comprising several distinct elements, and by means of a suitably programmed computer. In the device claim enumerating several means, several of these means can be embodied by one and the same item of hardware.

A ‘computer program’ is to be understood to mean any software product stored on a computer-readable medium, such as a floppy-disk, downloadable via a network, such as the Internet, or marketable in any other manner.

1. A system for storing and accessing information units the system comprising at least one storage device for storing respective ones of the information units, at least one presentation device for presenting the information units and a network connecting the storage device and the presentation device, wherein a respective information unit can be assigned to a physical location, the system further comprising positioning means for determining the physical location of the presentation device, and presentation control means for controlling the presentation of a respective information unit in dependence on the physical location of the presentation device and on the location to which the respective information unit is assigned.

2. A system as claimed in claim 1, the presentation control means being arranged to permit a full presentation of an information unit if the location of the presentation device and the location to which the respective information is assigned are substantially equal.

3. A system as claimed in claim 1 or 2, the presentation control means being arranged to permit a limited presentation of an information unit if there is a relatively small distance between the location of the presentation device and the location to which the respective information is assigned.

4. A system as claimed in any one of claims 1 to 3, the presentation control means being arranged to prohibit presentation of an information unit if there is a relatively large distance between the location of the presentation device and the location to which the respective information is assigned.

5. A system as claimed in any one of claims 1 to 4, the presentation device being a portable device.

6. A system as claimed in any one of claims 1 to 5, the presentation device being capable of creating and/or modifying an information unit which is assigned to the current physical location of the presentation device.

7. A system as claimed in any one of claims 1 to 6, the network being at least partly a wireless network.

8. A presentation device for use in a system as claimed in any one of claims 1 to 7.

9. A presentation device as claimed in claim 8, comprising positioning means for determining the physical location of the presentation device.

10. A presentation device as claimed in claim 9, said positioning means comprising a Global Positioning System unit.

11. A presentation device as claimed in any one of claims 8 to 10, comprising presentation control means for controlling the presentation of a respective information unit in dependence on the physical location of the presentation device and on the location to which the respective information unit is assigned.

12. A presentation device as claimed in any one of claims 8 to 11, the presentation device being a portable device.

13. A presentation device as claimed in any one of claims 8 to 12, the presentation device being capable of creating and/or modifying an information unit which is assigned to the current physical location of the presentation device.

14. A method of storing and accessing information units, comprising the steps of storing respective ones of the information units by means of at least one storage device, presenting respective ones of the information units by means of at least one presentation device, and connecting the storage device and the presentation device by means of a network, wherein the method further comprises the steps of assigning an information unit to a physical location, determining the physical location of the presentation device, and controlling the presentation of a respective information unit in dependence on the physical location of the presentation device and on the location to which the respective information unit is assigned.

15. A computer program product enabling a computer, when executing said computer program product, to function as a presentation device as claimed in any one of claims 8 to 13.
